(19) United States
(12) Patent Application Publication
(10) Pub. No.: US 2013/0258255 A1
(43) Pub. Date: Oct. 3, 2013

(54) IN-PLANE SWITCHING LIQUID CRYSTAL DISPLAY DEVICE

(71) Applicant: Jih-Hsin Fang, Tainan City (TW)

(72) Inventor: Jih-Hsin Fang, Tainan City (TW)

(21) Appl. No.: 13/589,195

(22) Filed: Aug. 20, 2012

(30) Foreign Application Priority Data
Mar. 28, 2012 (CN) 201210086718.8

(51) Int. Cl. G02F 1/1343; G02F 1/1337; G02F 1/1335

(52) U.S. Cl. 349/96; 349/139; 349/106; 349/123

(57) ABSTRACT

An in-plane switching (IPS) liquid crystal device comprises a first substrate and a second substrate opposite to each other, a liquid crystal layer between the first substrate and second substrate, a plurality of first pixel electrodes and first common electrodes alternately arranged on the first substrate, and a plurality of second common electrodes on the second substrate that are disposed at the position on the first substrate corresponding to the first common electrodes.

### BACKGROUND OF THE INVENTION

1. Field of the Invention

The present invention generally relates to a liquid crystal display device, more particularly, to an in-plane switching (IPS) liquid crystal display device.

2. Description of the Prior Art

In the technology of planar displays, liquid crystal display (LCD) devices have lower energy consumption and may easily reach the goals of thinner thicknesses and larger display as compared to conventional cathode ray tubes. Thus, the LCD devices have taken place of the conventional CRT devices and have become a mainstream in the display devices field. Generally, arrangements of liquid crystals in LCD device may be changed by applying an electric field to the liquid crystals. Since liquid crystals have properties such as fluidity and crystal optics, light transmitting through the liquid crystals may have a desired optical anisotropy, and an effect of displaying an image can be achieved. Depending on the various properties and patterns of the liquid crystals, the LCD devices may be classified into several categories, such as twisted nematic (TN), optically compensated birefringence (OCB), in-plane switching (IPS), or multi-domain vertical alignment (MVA). Each LCD display technology has its own advantages and disadvantages.

In the aforementioned LCD technologies, the in-plane switching (IPS) LCD device has excellent display performances, and is therefore widely used as the display device of desktop computers or notebooks. In comparison to the TN LCD device, the common electrodes and pixel electrodes of the IPS LCD device are disposed on the same glass substrate. The liquid crystals will be rotated in the same plane by a horizontal electric field generated between each common electrode and each pixel electrode. Thus, the light transmitted through the liquid crystals in IPS LCD device has no specific directionality, and an image that is generated by the IPS LCD device and observed in different viewing angles won't have color shift or grayscale inversion.

Please refer to FIG. 1, which is a cross-sectional view illustrating an IPS LCD device according to the prior art. As shown in FIG. 1, an IPS LCD device 100 comprises a first substrate 101, a second substrate 102, and a liquid crystal layer 103 disposed between the first substrate 101 and the second substrate 102. The liquid crystal layer 103 includes liquid crystals 104 arranged along a horizontal direction. The liquid crystals 104 have a specific rotation or a specific arrangement when an electric field is applied to the liquid crystals 104. The outer surface of the first substrate 101 is provided with a lower polarizer 105, and the inner surface of the first substrate 101 is formed with a plurality of common electrodes 106 and a plurality of pixel electrodes 107. Each common electrode 106 and each pixel electrode 107 are alternately arranged along a direction parallel to the inner surface of the first substrate 101. Since the common electrodes 106 and the pixel electrodes 107 are disposed on the same plane, the horizontal electric field will be generated between each common electrode 106 and each pixel electrode 107, and the liquid crystals in the liquid crystal layer 103 on the common electrodes 106 and the pixel electrodes 107 will be rotated in the horizontal direction. Data lines (not shown) are respectively disposed at two sides of each group of each common electrode 106 and each pixel electrode 107 that defines a pixel unit. A lower alignment film 108 covers the common electrodes 106 and the pixel electrodes 107 and contacts the liquid crystal layer 103. In comparison to the first substrate 101, an upper polarizer 109 is disposed on the outer surface of the second substrate 102, and a color filter 110 and an upper alignment film 111 are disposed on the inner surface of the second substrate 102 in sequence.

As shown in FIG. 1, since the common electrodes and the pixel electrodes in the conventional IPS LCD device 100 are disposed on the same substrate instead of being disposed respectively on the upper and lower substrates in other LCD technologies, the liquid crystals far away the pixel electrodes and the common electrodes have less rotating power and longer response time than the liquid crystals close to the pixel electrodes and the common electrodes. Furthermore, the electric field generated right on a center of each common electrode is less than that generated near an edge of each common electrode, so that the liquid crystals right on the center of each common electrode also have less rotating power. Thus, not only the IPS LCD device has slower response time but also the transmittance of the IPS LCD device is reduced. Therefore, how to increase the transmittance and the response time of the IPS LCD device is still an important research topic in the industry.

### SUMMARY OF THE INVENTION

The purpose of the present invention is to provide an in-plane switching (IPS) liquid crystal display (LCD) device with enhanced light transmittance and response time.

In one aspect of present invention, an IPS LCD device is provided. The IPS LCD device comprises a first substrate and a second substrate opposite to each other, a liquid crystal layer between the first substrate and the second substrate, multiple first pixel electrodes and first common electrodes alternately arranged on the first substrate, and multiple second common electrodes disposed at the position on the second substrate corresponding to the first common electrodes of the first substrate.

In another aspect of present invention, an IPS LCD device is provided. The IPS LCD device comprises a first substrate and a second substrate opposite to each other, a liquid crystal layer between the first substrate and the second substrate, multiple first pixel electrodes and first common electrodes alternately arranged on the first substrate, and multiple second common electrodes and second pixel electrodes disposed at the position on the second substrate corresponding to the first common electrodes and first pixel electrodes of the first substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute apart of this specification. The drawings illustrate some of the embodiments and, together with the description, serve to explain their principles. In the drawings:

FIG. 1 is a cross-sectional view of an IPS LCD device in prior art;

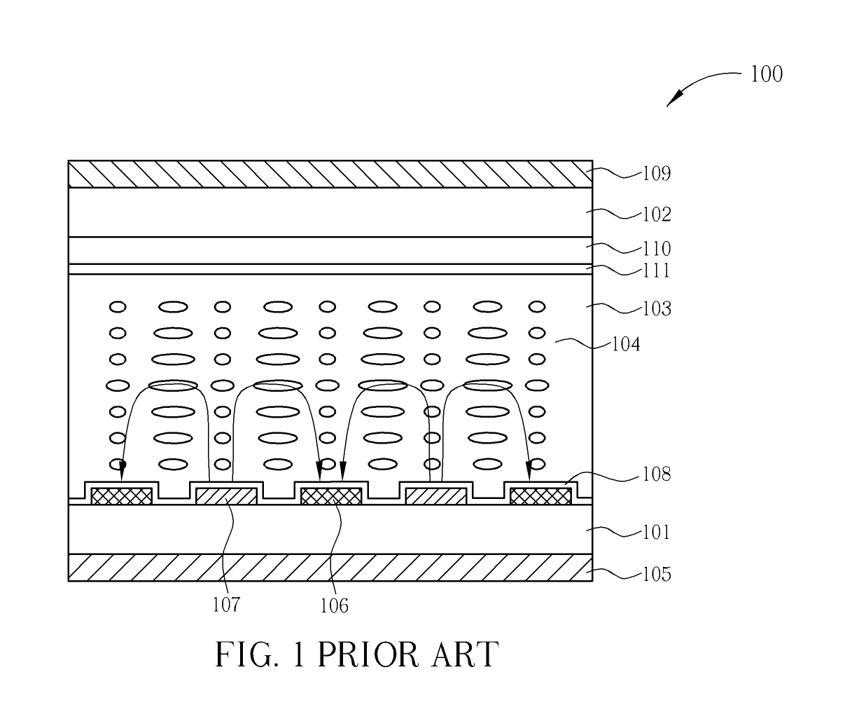

FIG. 2 is a cross-sectional view of an IPS LCD device in accordance with the first embodiment of present invention;

FIG. 3 is a cross-sectional view of an IPS LCD device in accordance with the second embodiment of present invention;

FIG. 4 is a graph showing the relational between the positions of common electrodes and pixel electrodes and the transmittance of the liquid crystal layer in conventional IPS LCD device;

FIG. 5 is a graph showing the relational between the positions of common electrodes and pixel electrodes and the transmittance of the liquid crystal layer in the IPS LCD device in the first embodiment of present invention; and

FIG. 6 is a graph showing the relational between the positions of common electrodes and pixel electrodes and the transmittance of the liquid crystal layer in the IPS LCD device in the second embodiment of present invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following description, numerous specific details are given to provide a thorough understanding of the invention. However, it will be apparent to one skilled in the art that the invention may be practiced without these specific details. In order to avoid obscuring the present invention, some well-known components, structures or configuration are not disclosed in detail.

The drawings showing embodiments of the apparatus are semi-diagrammatic and not to scale and, particularly, some of the dimensions are for the clarity of presentation and are shown exaggerated in the figures.

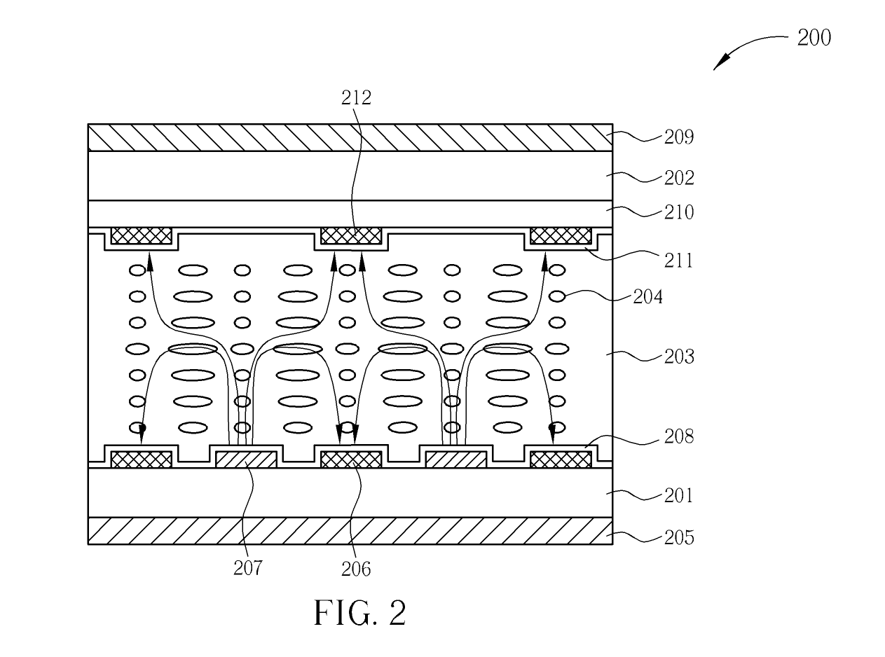

First, please refer to FIG. 2, which is a cross-sectional view of an in-plane switching (IPS) liquid crystal display (LCD) device in accordance with a first preferred embodiment of present invention. As shown in FIG. 2, the IPS LCD device 200 includes a first substrate 201, a second substrate 202 opposite to the first substrate 201, and a liquid crystal layer 203 between the first substrate 201 and second substrate 202. The first substrate 201 and second substrate 202 are made of transparent material, such as a glass substrate, which may allow light emitted from the backlight source to penetrate through. The liquid crystal layer 203 disposed between the first substrate 201 and the second substrate 202 comprises multiple liquid crystals 204. The liquid crystals 204 will be twisted or aligned to specific phases or orientations under the effect of the electric field. For example, the liquid crystals 204 may be tilted from their original horizontal orientation that is parallel to the substrate into a vertical orientation that is nearly perpendicular to the substrate, or may rotate on the horizontal plane.

A first polarizer 205 is disposed on the second surface of the first substrate 201 to polarize the light emitted from the backlight module (not shown). The polarized light may then transmit through the liquid crystal layer 203 with twisted liquid crystals 204. The amount of light transmitting therethrough is, therefore, limited, thereby controlling the grayscale presentation of the LCD screen. Multiple first common electrodes 206 and first pixel electrodes 207 are formed on the first surface of first substrate 201, wherein the first common electrodes 206 and first pixel electrodes 207 are alternately arranged. Both sides of the first common electrodes 206 and first pixel electrodes 207 are provided with data lines (not shown). The first pixel electrode 207 is electrically connected to a data line via thin film transistors. The switch of the thin film transistor is controlled by a gate line (not shown), thereby further controlling the communication of pixel driving signals to the pixel electrodes. The first common electrode 206 is electrically connected to a common line (not shown) and is further electrically connected to a common voltage (V_{com}) source via the common line. Please note that the aforementioned components, such as the backlight module, data line, gate line, common line, are not essential features of present invention. Thus, their detailed description is omitted herein for simplicity.

Since the first common electrode 206 and the first pixel electrode 207 are disposed on the same plane, a transverse electric field is formed therebetween so that the liquid crystals 204 in the liquid crystal layer 203 above may spin along a direction parallel to the substrate. The horizontal rotating degree of the liquid crystal 204 in the liquid crystal layer 203 is controlled by controlling the value of the transverse electric field, thereby controlling the gamma performance of the passed polarized light. Since the polarization direction of the polarized incident light is different from the original optical axis of the liquid crystal, the polarization model of the incident light will be changed by the phase retardation during the transmission.

A first alignment film 208 is formed on the entire first surface of the first substrate 201. The first alignment film 208 covers the first common electrodes 206 and the first pixel electrodes 207 and contacts the liquid crystal layer 203. The original alignment direction of the liquid crystals 204 in the liquid crystal layer 203 is decided by the first alignment film 208. In the IPS LCD device of the present invention, the liquid crystals 204 are aligned along a direction parallel to the first substrate 201 and the second substrate 202.

Please note that in alternative embodiment, the first common electrodes 206 and the first pixel electrodes 207 may not be disposed on the same plane. For example, there might be multilayer structures, such as stacked passivation layers and insulating layers (not shown), on the first substrate 201 rather than a single layer structure. The first common electrode 206 may be disposed on the first substrate 201 and covered by a passivation layer. The first pixel electrodes 207 may be disposed on the passivation layer and covered by the first alignment film 208.

On the other hand, as shown in FIG. 2, a second polarizer 209 is disposed on the second surface of the second substrate 202, while a color filter 210 is disposed on the first surface of the second substrate 202. The color filter 210 has pixel units of different colors which may filter the polarized light with different wavelength, such as red (R), green (G) and blue (B), so as to render the desired colors.

A plurality of second common electrodes 212 are formed on the first surface of the color filter 210. These second common electrodes 212 are disposed at the positions corresponding to the first common electrodes 206 on the first substrate 201. Unlike the configuration with no electrode disposed on the second surface of the IPS LCD device in prior art, the approach of disposing second common electrodes on the second substrate 202 in the present invention may build additional electric fields on the first surface of the second substrate 202, so that the liquid crystal 204 closer to the upper second substrate 202 in the liquid crystal layer 203 may be exerted by more horizontal rotatory forces, thereby improving the transmittance of the liquid crystal 204 in the liquid crystal layer 203 and effectively reducing the required driving voltage and reachable response time of the IPS LCD device 200.

An upper (second) alignment film 211 covers the second common electrodes 212 and contacts the liquid crystal layer 203. As described above, the first alignment film 208 and second alignment film 211 can decide of the original alignment direction of the liquid crystals 204 in the liquid crystal layer 203. In the IPS LCD device of the present invention, the liquid crystals 204 are aligned along a direction parallel to the first substrate 201 and the second substrate 202.

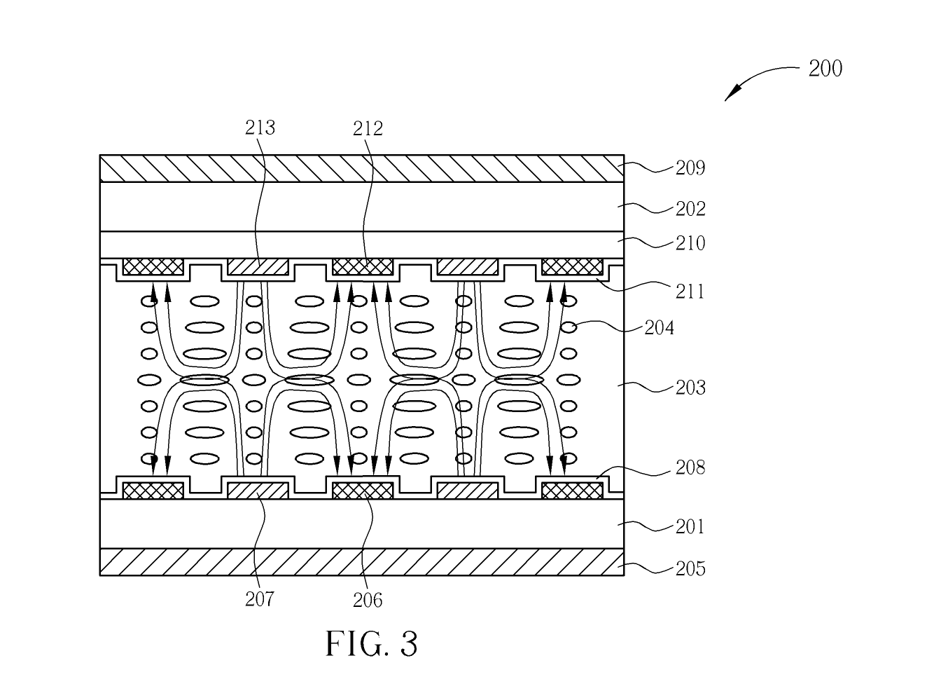

Then, please refer to FIG. 3, which is a cross-sectional view of an IPS LCD device in accordance with the second embodiment of the present invention. As shown in FIG. 3, the difference between the embodiment of FIG. 3 and the embodiment of FIG. 2 is that the first surface of second substrate 202 in FIG. 3 is provided with multiple second pixel electrodes 213. The second pixel electrodes 213 on the second substrate 202 are disposed at the positions corresponding to the first pixel electrodes 207 on the first substrate 201 and are alternately arranged with the second common electrodes 212. The advantage of this approach is that the horizontal transverse electric field formed on the surface of second substrate 202 is identical to the one formed on the surface of the first substrate 201, so that the liquid crystals 204 closer to the upper second substrate 202 in the liquid crystal layer 203 maybe exerted by more horizontal rotatory forces, thereby further improving the transmittance of the liquid crystal layer 203 and effectively reducing the necessary driving voltage and reachable response time of the IPS LCD device 200.

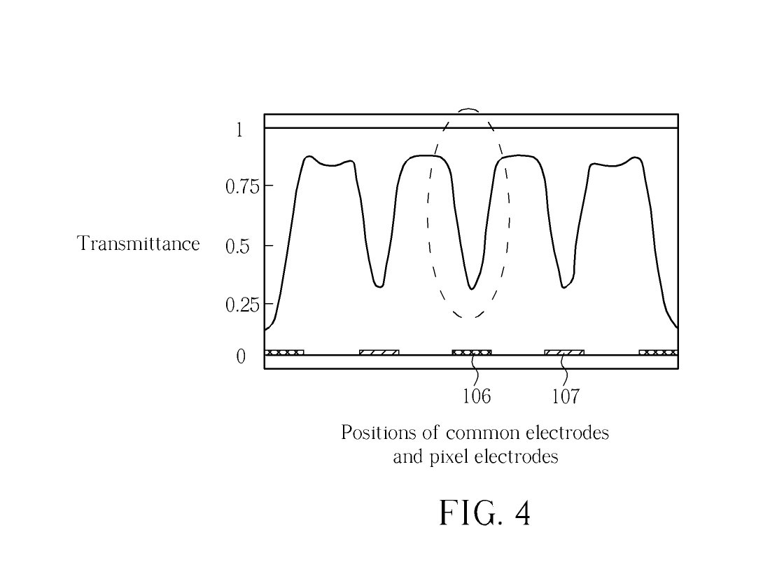

Now, please refer to FIGS. 4-6, which are graphs respectively showing the relation between the positions of the common electrodes and the pixel electrodes and the transmittance of the liquid crystal layer in the IPS LCD device of prior art, the first embodiment of present invention and the second embodiment of present invention. First, as shown in FIG. 4, in conventional IPS LCD devices, since the common electrodes 106 and pixel electrodes 107 on the first substrate are alternately arranged, the transverse electric field is formed primarily at the position between the common electrodes 106 and the pixel electrodes 107, the electric field has a lower influence on the position which is perpendicular to the common electrodes 106 and pixel electrodes 107 in the liquid crystal layer. Therefore, the curve of the transmittance of the LCD device may have the trench type distribution shown in FIG. 4, wherein the position between the common electrodes and the pixel electrodes have relatively large transmittance, while the position perpendicular to the common electrodes and the pixel electrodes have the lowest transmittance. Dark strips may be easily observed by the user because of this kind of transmittance distribution in conventional IPS LCD devices.

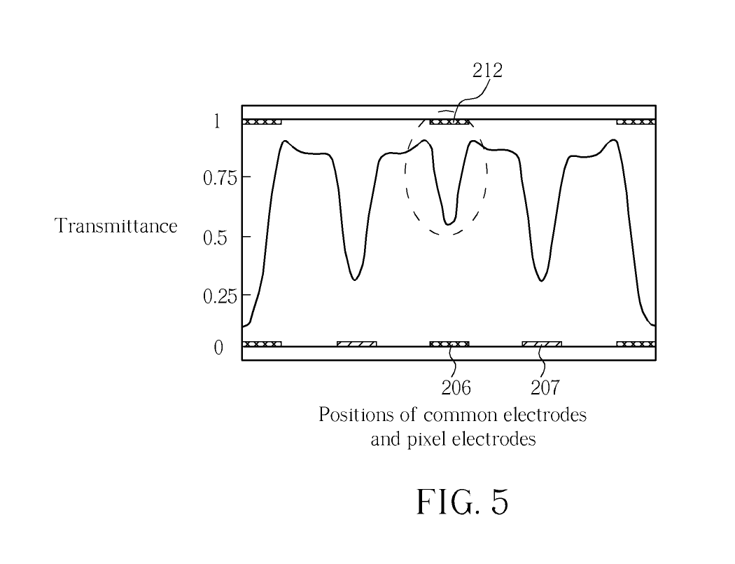

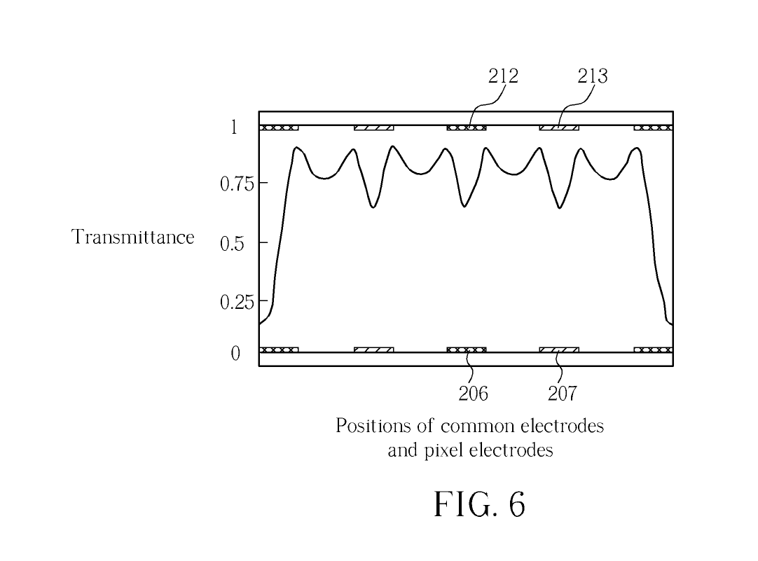

For the IPS LCD device of the first embodiment of the present invention, as shown in FIG. 5, since the second substrate is additionally disposed with second common electrodes 212, the transmittance in the middle position of the LCD device (as the encircled region by the dash line shown in FIG. 5) is significantly improved from 65.4% to 68.1%. For the IPS LCD device in the second embodiment of present invention, as shown in FIG. 6, since the second substrate is provided with alternately arranged common electrodes 212 and pixel electrodes 213 like the ones disposed on the first substrate, the transmittances at the positions perpendicular to the common electrodes 212 and pixel electrodes 213 are further improved from 65.5% to 74.32% in comparison to the first embodiment.

It is obvious to understand in light of the aforementioned embodiments that all liquid crystals in the liquid crystal layer may be exerted by a larger, more uniform electric field through the approach of disposing electrodes on the second substrate in the present invention to form additional electric fields, thereby improving the transmittance and response time of the display device and solving the dark strips issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An in-plane switching liquid crystal display device, comprising:
a first substrate and a second substrate opposite to each other;
a liquid crystal layer between said first substrate and said second substrate;
a plurality of first pixel electrodes on a first surface of said first substrate;
a plurality of first common electrodes on the first surface of said first substrate, wherein each of said first pixel electrodes and each of said first common electrodes are alternately arranged along a direction; and
a plurality of second common electrodes disposed on the first surface of said second substrate respectively corresponding to said first common electrodes.

2. The in-plane switching liquid crystal display device according to claim 1, further comprising a plurality of second pixel electrodes on a first surface of said second substrate, wherein each of said second pixel electrodes and each of said second common electrodes are alternately arranged along said direction, and each of said second pixel electrodes is disposed corresponding to each of said first pixel electrodes.

3. The in-plane switching liquid crystal display device according to claim 1, further comprising a first polarizer and a second polarizer disposed respectively on a second surface of said first substrate and a second surface of said second substrate.

4. The in-plane switching liquid crystal display device according to claim 1, further comprising a color filter on a first surface of said second substrate.

5. The in-plane switching liquid crystal display device according to claim 1, further comprising a first alignment film disposed on the first surface of said first substrate and covering said first common electrodes and said first pixel electrodes.

6. The in-plane switching liquid crystal display device according to claim 2, further comprising a second alignment film disposed on the first surface of said second substrate and covering said second common electrodes and said second pixel electrodes.
